(19) United States
(12) Patent Application Publication
(10) Pub. No.: US 2025/0306870 A1
(43) Pub. Date: Oct. 2, 2025

(54) GENERATING TRANSFORMED CODE USING A LARGE LANGUAGE MODEL

(71) Applicant: Microsoft Technology Licensing, LLC, Redmond, WA (US)

(72) Inventors: Benjamin W. HENDRICKS, New Orleans, LA (US); Ngan Hoang Kim LE, San Francisco, CA (US); Shailesh C. JANNU, Fremont, CA (US)

(21) Appl. No.: 18/625,070

(22) Filed: Apr. 2, 2024

(51) Int. Cl. G06F 8/40

(52) U.S. Cl. CPC G06F 8/40

(57) ABSTRACT

The present disclosure relates to systems, non-transitory computer-readable media, and methods for generating and providing transformed code snippets using a large language model. In particular, the disclosed systems can determine a code snippet from a code, for instance, based on user selection of the code snippet. The disclosed system can analyze the code and/or the code snippet to generate a prompt comprising context. The context contains information about the functionality of the code. The disclosed systems further use a large language model to analyze the code snippet and the prompt comprising the context and generate transformed code. The disclosed systems may provide the transformed code snippet to one or more devices.

### BACKGROUND

Recent years have seen significant improvements in technology for software development, necessitating the continuous adaptation of existing systems to meet the demands of various computing environments. The emergence of new programming paradigms and frameworks, together with the exponential growth of mobile and other platforms has prompted developers to optimize and refactor codebases to ensure compatibility across diverse device ecosystems. Additionally, the transition to cloud-native architectures has spurred migrations aimed at modernizing legacy applications and infrastructure. Furthermore, the advent of new programming languages, tools, and frameworks has provided developers with innovative solutions to address evolving technical challenges, driving the need for code migration to leverage these advances. As technology continues to evolve, existing systems are required to execute code migrations to harness modern software development more fully.

These along with additional problems and issues exist with regard to conventional code migration systems.

### SUMMARY

Embodiments of the present disclosure provide benefits and/or solve one or more of the foregoing or other problems in the art with systems, non-transitory computer-readable media, and methods for generating and providing transformed code snippets using a large language model. The disclosed systems can leverage artificial intelligence to complete large scale migrations. More particularly, the disclosed systems can access a code snippet from code to be migrated. The disclosed systems can generate a prompt based on analysis of the code to be migrated. The prompt may include code context that provides information relating to the code's functionality and dependencies. In some implementations, the disclosed systems use the prompt with the code snippet as input into a large language model. The disclosed systems may utilize the large language model to generate a transformed code snippet corresponding to the code snippet. In some implementations, the disclosed systems provide the transformed code snippet for display to one or more users.

Additional features and advantages of one or more embodiments of the present disclosure are outlined in the description which follows, and in part can be determined from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a schematic diagram of an example system environment for implementing a code transformation system in accordance with one or more embodiments.

FIG. 2 illustrates an example overview of the code transformation system generating a transformed code snippet in accordance with one or more implementations of the present disclosure.

FIG. 3 illustrates the code transformation system using a prompt model to generate a prompt in accordance with one or more implementations of the present disclosure.

FIGS. 4A-4B illustrate the code transformation system training the prompt model and the large language model in accordance with one or more implementations of the present disclosure.

FIG. 5 illustrates the code transformation system determining code snippets from code in accordance with one or more embodiments of the present disclosure.

FIG. 6 illustrates the code transformation system generating transformed code by using an interactive AI assisted transformation approach in accordance with one or more embodiments of the present disclosure.

FIG. 7 illustrates an example prompt template in accordance with one or more embodiments of the present disclosure.

FIGS. 8A-8C illustrate example code transformation user interfaces in accordance with one or more embodiments of the present disclosure.

FIG. 9 illustrates an example series of acts for providing transformed code using a large language model in accordance with one or more embodiments.

FIG. 10 illustrates a block diagram of an example computing device for implementing one or more embodiments of the present disclosure.

FIG. 11 illustrates an example large language model in accordance with one or more implementations.

### DETAILED DESCRIPTION

This disclosure describes one or more embodiments of a code transformation system that generates and provides code transformations using a large language model. The code transformation system can leverage artificial intelligence to complete large scale migrations. In particular, the code transformation system can use a large language model to generate a transformed code snippet from a code snippet of a code. The code transformation system can pre-process the input code to ensure that it complies with input requirements with a large language model. The code transformation system may further generate a prompt comprising context that contains information relating to the input code. The code transformation system can insert the pre-processed code into the prompt and use a large language model to process the prompt. The large language model can use its understanding of the code based on the context to accurately transform the code snippet. The code transformation system can use the large language model to generate transformed code. In some examples, the code transformation system provides the transformed code for display via a user interface.

In particular, the code transformation system determines a selection of a code snippet from a code associated with a first code type. The code transformation system can display the code snippet via a user interface of a first user device. The code transformation system can, based on the selection of the code snippet, generate a prompt comprising a context associated with the code, wherein the context is related to a functionality of the code. Furthermore, code transformation system may, using a large language model, generate a transformed code snippet of a second code type using the code and the context and based on the large language model understanding of the context of the code. The code transformation system may further cause a second user interface to display the transformed code snippet.

Code transformations may refer to the process of converting code from one programming language or platform to another. Code transformations may be beneficial in several use cases. To illustrate, code may be translated from one programming language to another. Furthermore, code may be transformed as part of moving the code from one platform or framework to another. Code may be transformed to make it compatible across different platforms or devices—for instance code for a mobile app may be transformed to work on different operating systems. Code transformations may also improve the performance or efficiency of existing code by transforming the code into a more optimized form. Additionally, code may be transformed as part of combining multiple codebases into a single, unified codebase to simplify maintenance and support. Furthermore, code may be transformed as part of converting it to a standardized format to ensure compatibility and interoperability across different systems.

As mentioned, the code transformation system can determine a code snippet from a code. In some implementations, large language models are limited in the size of input they can efficiently and accurately process. Accordingly, in some embodiments, the code transformation system identifies a code snippet from a code. For example, the code transformation system can receive a user selection indicating a code snippet from an input code. In another example, the code transformation system can automatically determine one or more code snippets from a code.

In some embodiments, the code transformation system generates a prompt comprising a context associated with the code. Large language models often excel at understanding context when generating text. The code transformation system leverages this trait of large language models to generate accurate code transformations. To illustrate, the code transformation can generate context that includes information regarding the functionality and dependencies of the code from which a snippet is taken. By including context in a prompt for a large language model, the large language model can form a contextual understanding that reduces the likelihood of errors.

Furthermore, as previously mentioned, the code transformation system can use a large language model to generate a transformed code snippet. In particular, the code transformation system inserts the code snippet into the prompt comprising context. The code transformation system further inputs the prompt and the code snippet into the large language model. The large language model generates a transformed code snippet corresponding with the code snippet.

Some existing systems employ various methods for transforming code in preparation for code migrations. However, existing systems often face technical challenges in transforming code. For example, existing systems are often inaccurate. Existing systems often utilize techniques of structured search and replace, AST rewriting, or even regexes to migrate code. The above-listed methods for migrating code require many existing systems to rely on users to correctly write, and debug transformed code. For instance, writing and debugging regex patterns or AST manipulation can be error-prone, especially for complex code. Search and replace operations may also lack the precision needed to accurately identify and modify specific code patterns or structures. Small mistakes in the pattern or code can lead to errors in the migrated code.

Additionally, existing systems often rely on methods that are computationally expensive. Regular expressions and AST rewriting operations can also be computationally intensive, especially for large codebases or complex migration tasks. A major limitation of existing models is input and output size (i.e., token limits). Existing systems can process a set number of tokens (e.g., words, subwords, or characters) in a single input. The limited input and output size of existing systems often precludes them from processing large and complex codebases. Existing systems may be subject to slow execution times and high resource usage, making the migration process computationally inefficient.

Furthermore, existing systems are often navigationally inefficient in producing code for complex migrations. Existing systems are often inefficient because they require users to perform multiple steps to create migratable code—especially for complex code. For instance, large and complex codebases may comprise a variety of patterns, structures, and edge cases that need to be individually addressed during migration. Users must often perform multiple steps to identify and handle each of the patterns individually using different methods.

The code transformation system can improve accuracy and efficiency relative to existing code migration systems. In contrast to existing systems that rely on error-prone user modifications to a codebase, the code transformation system utilizes a large language model which can improve in accuracy over the lifespan of a migration and over the course of many migrations. In particular, the code transformation system can make improvements to accuracy by accessing or generating prompts comprising context about a migration. The context reflects information regarding the functionality and dependencies of the overall code. For example, the code transformation can generate the context based on code segments preceding and following a selected code snippet. By inserting code context into a prompt, the code transformation system can minimize hallucination, errors, latency, and achieve accurate transformation of a code snippet.

Additionally, the code transformation system can be more computationally efficient relative to existing systems. Generally, large language models excel at understanding natural language, including its nuances, context, and semantics. In contrast to existing systems that often require additional pipelines for tasks such as parsing, pattern matching, and language understanding, a large language model often offers end-to-end processing capabilities and can often handle a wide range of tasks within a single model. Thus, by using a large language model to generate a transformed code snippet, the code transformation can improve computational efficiency relative to existing systems.

The code transformation system can also improve navigational efficiency compared to prior systems. By providing a code transformation user interface that provides a transformed code snippet, the code transformation system improves efficiency relative to existing systems. Specifically, existing systems often require users to manually identify and modify individual patterns within a codebase. In contrast, the code transformation system provides a code transformation user interface by which the code transformation system can receive a code snippet and automatically provide a transformed code snippet. Accordingly, the code transformation system not only introduces new functionality not found in prior systems but also reduces the number of interfaces and user interactions for generating and presenting transformed code snippets relative to prior systems. Relatedly, the code transformation system improves computational efficiency by processing fewer user interactions, thereby consuming fewer computer resources, such as processing power and memory, as compared to existing systems.

As illustrated by the foregoing discussion, the present disclosure utilizes a variety of terms to describe features and advantages of the activity difference system. Additional detail is now provided regarding the meaning of such terms. For example, as used herein, the term “code” refers to an implementation of software or programming instruction to perform specific functions. In particular, code can comprise a set of instructions, or a system of rules, in a given programming language. Code may comprise to-be migrated code or code that is to be transferred from one environment, platform, or system to another environment, platform, or system. For example, code can encompass a wide range of programming languages, frameworks, and technologies.

As used herein, the term “code snippet” refers to a segment of code. More specifically, a code snippet refers to a segment of code to be transformed and migrated to a different environment or context. For example, a code snippet may comprise a segment of code that has a size that falls within a token limit. Additionally, a code snippet may comprise code of a first code type. In some examples, a code snippet comprises a previously transformed segment of code.

As used herein, the term “prompt” refers to an instructional request or input given to a large language model to guide the completion of a task. In particular, a prompt can include instructions for eliciting a response that provides transformed code and/or code changes. A prompt can include context that guides a large language model's output. Additionally, a prompt can include code, such as a code snippet, that requires transformation. In some implementations, a prompt includes transformation examples that include an example of pre-transformed code and an example of the desired transformed code.

As used herein, the term “context” refers to relevant details about code that guides the completion of a task by a large language model. In particular, context comprises background information, constraints, or specifications provided to guide the completion of a task by a large language model. More specifically, context comprises a code and its surrounding comments that indicate the code's functionality and dependencies. For instance, context may include a description for code, code snippets, transformed code descriptions, and the desired transformed code snippet. Context may be derived from code surrounding a code snippet or from the code as a whole, inclusive of the code snippet. In one example, context may comprise information representing code segments above and below a code snippet.

As used herein, the term “code type” refers to a classification of a programming language based on its characteristics and intended use. In particular, a code type indicates a classification of programming language that is compatible with a platform or framework. For example, a code type may indicate a programming language (e.g., Java, Python, C, C++, etc.). In another example, a code type indicates compatibility with a given platform (e.g., Resli, GraphQL, etc.). Additionally, a code type may indicate that a programming language is in a particular form (e.g., an optimized form). For example, a code of a first type may be transformed to a code of a second type.

As used herein, the term “large language model” refers to a machine learning model trained to perform computer tasks to generate or identify content items in response to trigger events (e.g., user interactions, such as text queries, prompts, and button selections). In particular, a large language model can be a neural network with many parameters trained on large quantities of data (e.g., unlabeled text) using a particular learning technique (e.g., self-supervised learning). For example, a large language model can include parameters trained to generate or identify content items based on various contextual data, including graph information from a knowledge graph and/or historical user account behavior. Additionally, a large language model may comprise a generative pre-trained transformer (GPT) model. For instance, a large language model may comprise Open AI Text Davinci, CODIT-T5, UnixCoder and GraphCodeBert, or another type of large language model.

Relatedly, the term “neural network” refers to a machine learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., content change summaries or user account activity summaries) based on a plurality of inputs provided to the neural network. In some cases, a neural network refers to an algorithm (or set of algorithms) that implements deep learning techniques to model high-level abstractions in data. A neural network can include various layers such as an input layer, one or more hidden layers, and an output layer that each perform tasks for processing data. For example, a neural network can include a deep neural network, a convolutional neural network, a recurrent neural network (e.g., an LSTM), a graph neural network, or a generative adversarial neural network. Upon training, such a neural network may become a large language model.

As used herein, the term “transformed code snippet” refers to a modified or adapted segment of source code that has undergone alterations to meet specific objectives. More specifically, a transformed code snippet may have undergone modification to meet specific coding objectives. In particular, a transformed code snippet comprises a modified version of a code snippet. For example, a transformed code snippet may comprise a segment of modified codes that may be migrated.

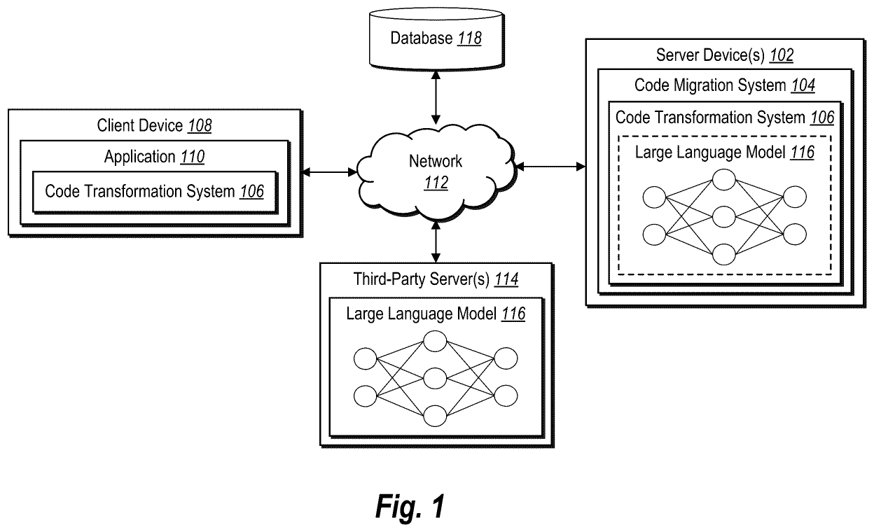

Additional detail regarding the activity difference system will now be provided with reference to the figures. For example, FIG. 1 illustrates a schematic diagram of an example system environment for implementing a code transformation system 106 in accordance with one or more embodiments. An overview of the code transformation system 106 is described in relation to FIG. 1. Thereafter, a more detailed description of the components and processes of the code transformation system 106 is provided in relation to the subsequent figures.

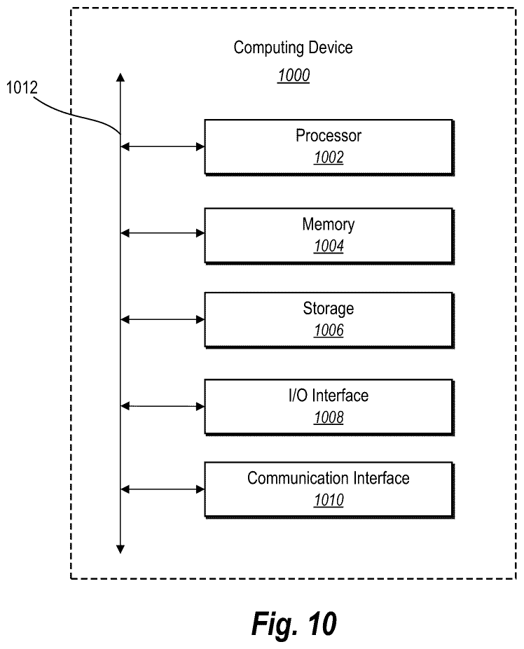

As shown, the environment includes server device(s) 102, a client device 108, a network 112, and third-party server(s) 114. Each of the components of the environment can communicate via the network 112, and the network 112 may be any suitable network over which computing devices can communicate. Example networks are discussed in more detail below in relation to FIG. 10.

As mentioned above, the example environment includes client device 108. The client device 108 can be one of a variety of computing devices, including a smartphone, a tablet, a smart television, a desktop computer, a laptop computer, a virtual reality device, an augmented reality device, or another computing device as described in relation to FIG. 10. The client device 108 can communicate with the server device(s) 102 and/or the database 118 via the network 112. For example, the client device 108 can receive user input from a user interacting with the client device 108 (e.g., via the application 110) to, for instance, access, generate, modify, or share code, to collaborate with a co-user of a different client device, or to select a user interface element (e.g., for generating a transformed code snippet and/or code snippet changes). In addition, the code transformation system 106 on the server device(s) 102 can receive information relating to various interactions with code, transformed code, and/or user interface elements based on the input received by the client device 108 (e.g., to generate transformed code, modify transformed code, generate prompts, modify prompts, or perform some other action).

As shown, the client device 108 can include an application 110. In particular, the application 110 may be a web application, a native application installed on the client device 108 (e.g., a mobile application, a desktop application, etc.), or a cloud-based application where all or part of the functionality is performed by the server device(s) 102. Based on instructions from the application 110, the client device 108 can present or display information, including a user interface for presenting code, prompts, or transformed code from the code migration system 104 or from other network locations.

In some implementations, the client device 108 may communicate directly with the third-party server(s) 114. In particular, the code transformation system 106 of the application 110 may implement a chat assistant or bot that facilitates code transformations. Based on user interaction with the chat assistant, the code transformation system 106 may access the large language model 116 located on the third-party server(s) 114. In some examples, the application 110 of the client device 108 communicates with the large language model 116 located on the third-party server(s) 114 directly or via an API.

As illustrated in FIG. 1, the example environment also includes the server device(s) 102. The server device(s) 102 may generate, track, store, process, receive, and transmit electronic data, such as code snippets, transformed code snippets, prompts, transformation examples, interface elements, interactions with code, interactions with interface elements, and/or interactions between user accounts or client devices. For example, the server device(s) 102 may receive data from the client device 108 in the form of an indication of a user account accessing a code and its corresponding snippets or a collaborative workspace. In addition, the server device(s) 102 can transmit data to the client device 108 in the form of code transformation user interfaces that includes an automatically (e.g., without user interaction for prompting) generated transformed code ready for migration and/or a prompt for a large language model for generating the transformed code. Indeed, the server device(s) 102 can communicate with the client device 108 to send and/or receive data via the network 112. In some implementations, the server device(s) 102 comprise(s) a distributed server where the server device(s) 102 include(s) a number of server devices distributed across the network 112 and located in different physical locations. The server device(s) 102 can comprise one or more content servers, application servers, communication servers, web-hosting servers, machine learning server, and other types of servers.

As shown in FIG. 1, the server device(s) 102 can also include the code transformation system 106 and the database 118 as part of a code migration system 104. The code migration system 104 can communicate with the client device 108 to perform various functions associated with the application 110 such as managing user accounts, managing code repositories, managing code collections, managing prompt collections, and facilitating user interaction with a large language model, code, transformed code, and code snippets. Indeed, the code migration system 104 can include a network-based smart cloud storage system to manage, store, and maintain code and related data across numerous user accounts, including user accounts in collaboration with one another. In some embodiments, the code transformation system 106 and/or the code migration system 104 utilizes the database 118 to store and access information such as code and prompts. For example, the database 118 can store code repositories that are accessible by several client devices.

FIG. 1 further illustrates third-party server(s) 114. In particular, the third-party server(s) 114 can host or house a large language model 116 for access by the code transformation system 106. Indeed, the code transformation system 106 can access the large language model 116. For example, the third-party server(s) 114 can include a server location hosting the large language model 116 that is external to the code transformation system 106. In some cases, the third-party server(s) 114 are external to the code transformation system 106, but the code transformation system 106 can nevertheless access and utilize the large language model 116 via one or more plugins, APIs, or other network-based access protocols.

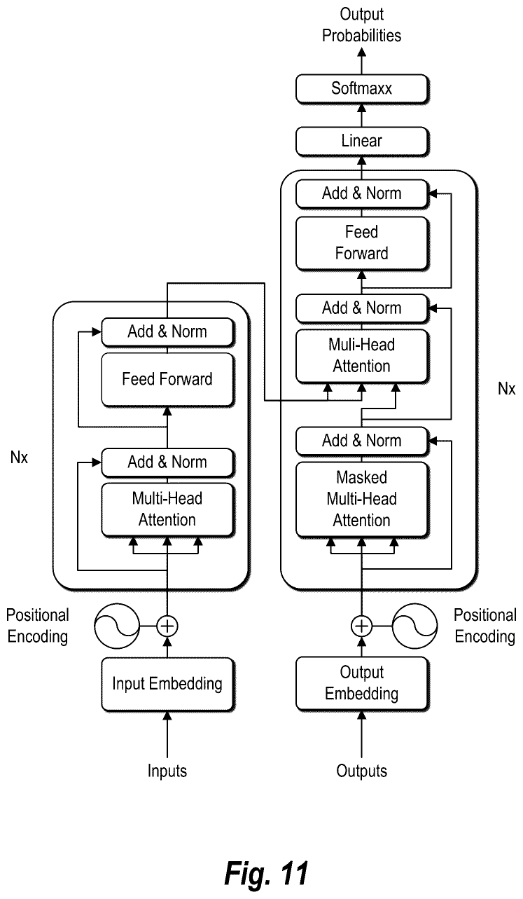

As shown in FIG. 1, the third-party server(s) 114 may host the large language model 116. In some implementations, the large language model 116 is hosted by the code transformation system 106 on the device(s) 102. In yet other implementations, the large language model 116 is hosted on a server of the client device 108. For example, the large language model 116 can be stored within a storage of the client device 108. In some examples, the large language model 116 is stored across multiple devices. FIG. 11 illustrates an example large language model 116 in accordance with one or more implementations of the present disclosure.

Although FIG. 1 depicts the code transformation system 106 located on the server device(s) 102, in some implementations, the code transformation system 106 may be implemented by (e.g., located entirely or in part on) one or more other components of the environment. For example, the code transformation system 106 may be implemented by the client device 108. For example, the client device 108 can download all or part of the code transformation system 106 for implementation independent of, or together with, the server device(s) 102.

In some implementations, though not illustrated in FIG. 1, the environment may have a different arrangement of components and/or may have a different number or set of components altogether. For example, the client device 108 may communicate directly with the code transformation system 106, bypassing the network 112. As another example, the environment can include the database 118 located external to the server device(s) 102 (e.g., in communication via the network 112), located on the server device(s) 102 as illustrated in FIG. 1, and/or on the client device 108.

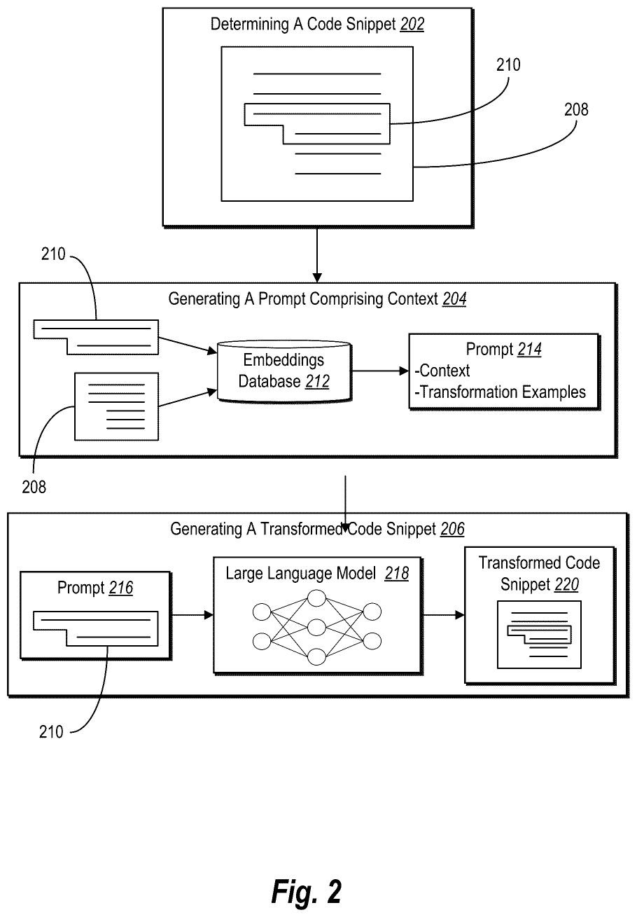

As previously mentioned, the code transformation system 106 can generate and provide transformed code to facilitate code migration using a large language model. FIG. 2 illustrates an example overview of generating a transformed code snippet in accordance with one or more implementations of the present disclosure.

As shown in FIG. 2, the code transformation system 106 can perform an act 202 of determining a code snippet. In some examples, the code transformation system 106 receives, as input from a client device (e.g., the client device 108), a code 208 to be migrated. As mentioned, the code 208 can be associated with a first code type that is compatible with a first environment, platform, or system. The code transformation system 106 can determine to transform the code 208 to a second code type so that it can be compatible with and migrated into a second environment, platform, or system. In some embodiments, the code transformation system 106 receives the code snippet and not code.

The code transformation system 106 may determine several use cases for code transformation. For instance, the code transformation system 106 may determine to transform code for language translation. More specifically, the code transformation system 106 can determine to translate code from one programming language to another, such as from Java to Python or from C to C++. Additionally, the code transformation system 106 may determine to transform code for platform migration, which comprises moving code from one platform or framework to another, such as from Resli to GraphQL. Additionally, the code transformation system 106 may determine to transform code for optimization to improve the performance or efficiency of existing code by transforming the existing code to a more optimized form. The code transformation system 106 may further determine to transform code for the purpose of consolidation by combining multiple codebases into a single, unified codebase to simplify maintenance and support. The code transformation system 106 may also determine to transform code for standardization. More specifically, the code transformation system 106 can convert code to a standardized format to ensure compatibility and interoperability across different systems.

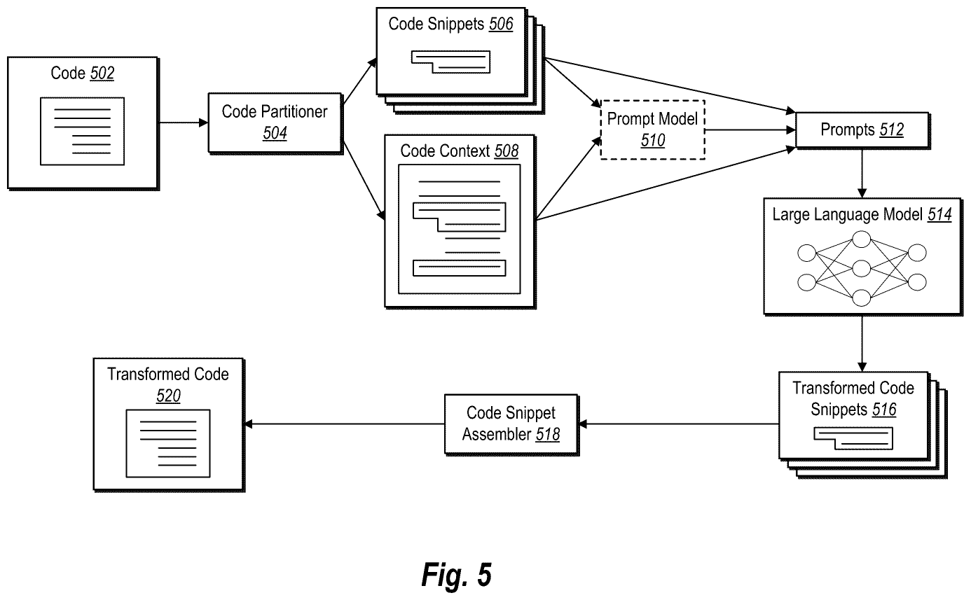

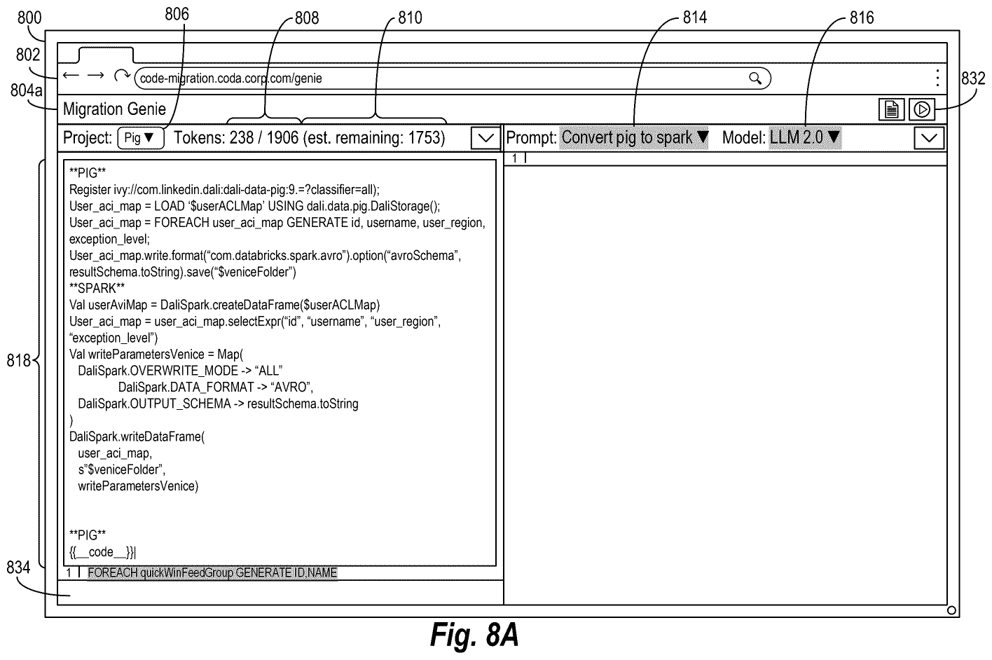

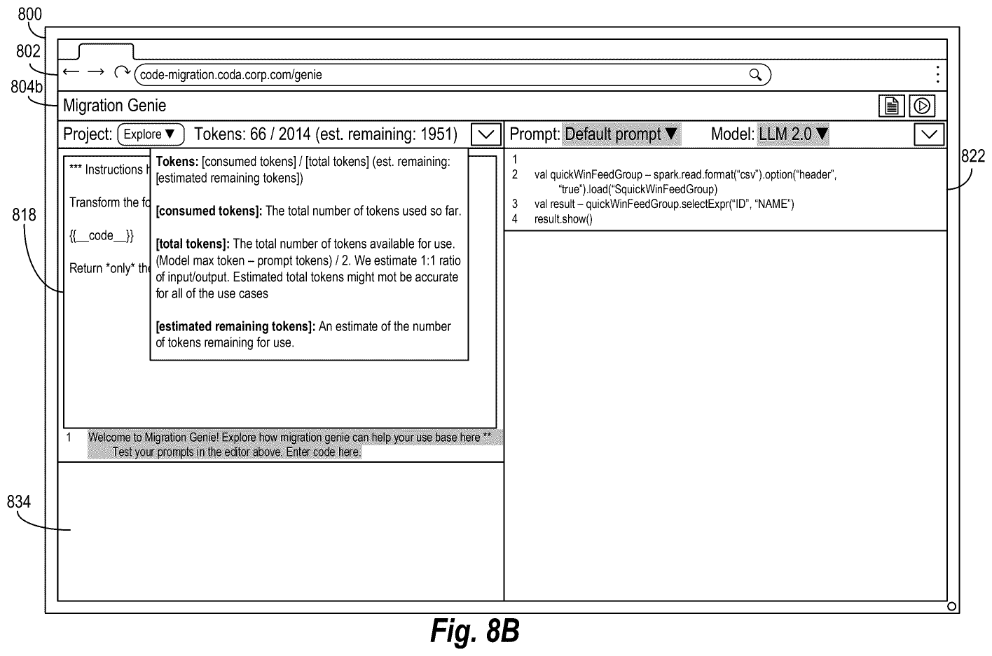

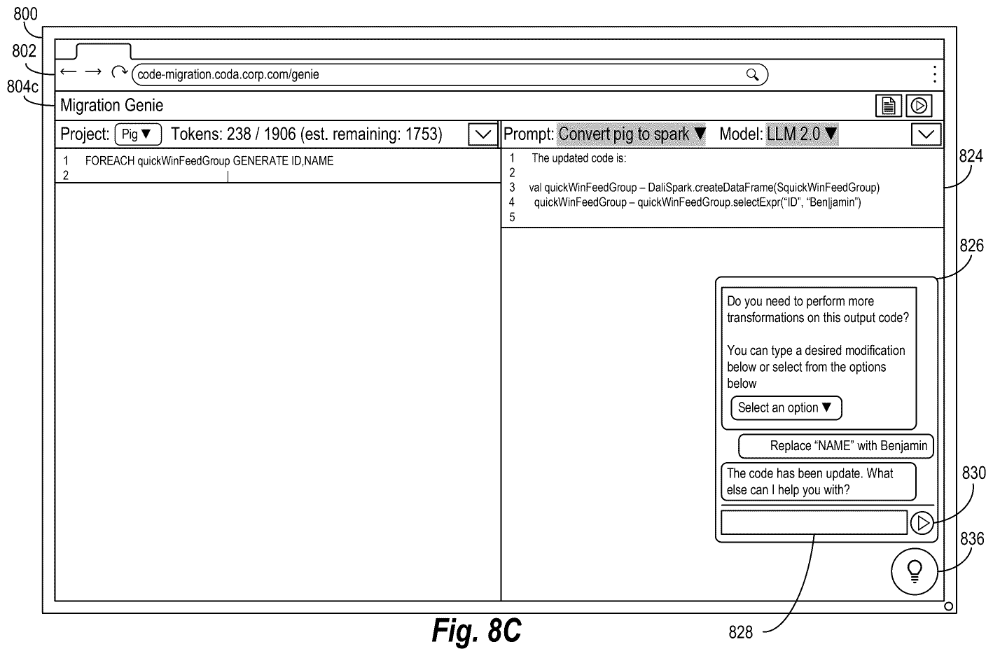

In some implementations, the code transformation system 106 determines a code snippet from the code 208. In some examples, the code 208 comprises a large file that exceeds a large language model's token limit. More specifically, the code transformation system 106 might determine that a large language model (LLM) may more accurately transform smaller segments of code. Accordingly, the code transformation system 106 can break up the code 208 into smaller segments or snippets. As shown in FIG. 1, the code transformation system 106 can determine the code snippet 210 from the code 208. FIG. 5 and the corresponding discussion further detail how the code transformation system 106 can determine the size and bounds of code snippets in accordance with one or more implementations of the present disclosure. In some implementations, the code transformation system 106 receives the code 208 (and/or the code snippet 210) via a code transformation user interface on a device. FIGS. 8A-8C illustrate example code transformation user interfaces in accordance with one or more embodiments of the present disclosure.

As further shown in FIG. 2, the code transformation system 106 may perform an act 204 of generating a prompt comprising context. In particular, the code transformation system 106 generates a prompt comprising context based on the code 208. More particularly, the code transformation system 106 analyzes the code 208 and generates context to include within a prompt. For instance, in some implementations, the code transformation system 106 analyzes the functionality and dependencies of the code 208 as a whole and generates context. In some implementations, the code transformation system 106 analyzes segments of the code 208 that precede or follow the code snippet 210 and generates context based on the segments preceding or following the code snippet 210. In some examples, the code transformation system 106 determines the prompt based on the code snippet 210. In particular, the code transformation system 106 can generate context based on analysis of the code snippet 210.

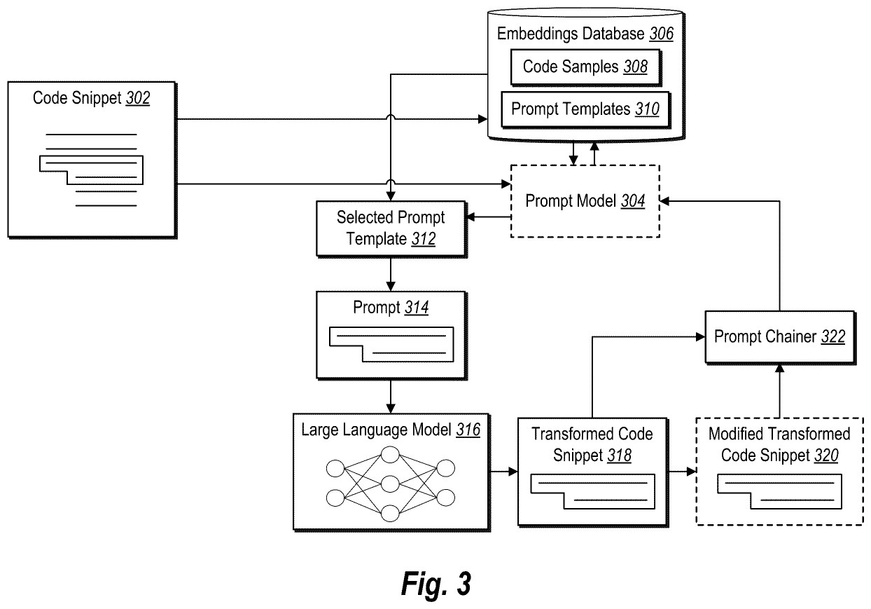

The code transformation system 106 can determine a prompt utilizing an embeddings database 212. The embeddings database 212 can store embeddings of prompt templates and sample code snippets (and/or sample code) corresponding to the prompt templates. More specifically, the embeddings database 212 may include prompt templates having different contexts corresponding to the sample code snippets. The code transformation system 106 may, thus, automatically generate context based on other code snippets. The code transformation system 106 may compare the code 208 and/or the code snippet 210 with the sample code or the sample code snippets within the embeddings database 212 to identify a corresponding prompt template. The code transformation system 106 generates a prompt 214 based on the comparison. FIG. 3 and the corresponding paragraph provide additional detail regarding how the code transformation system 106 determines a prompt in accordance with one or more embodiments of the present disclosure.

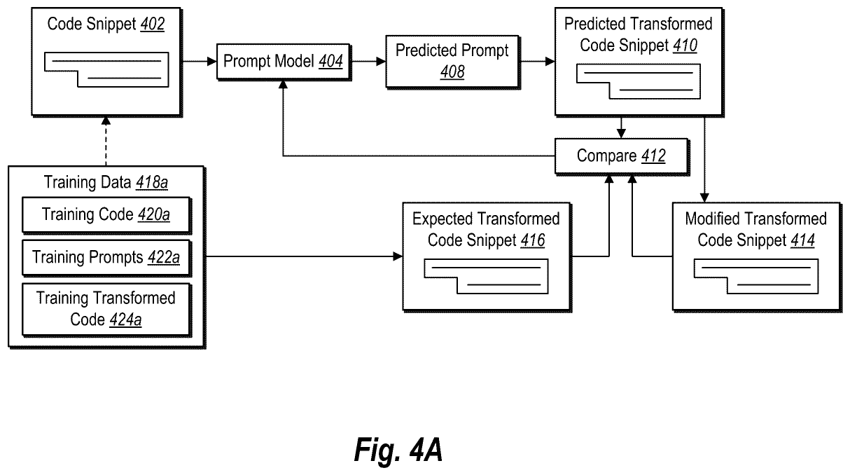

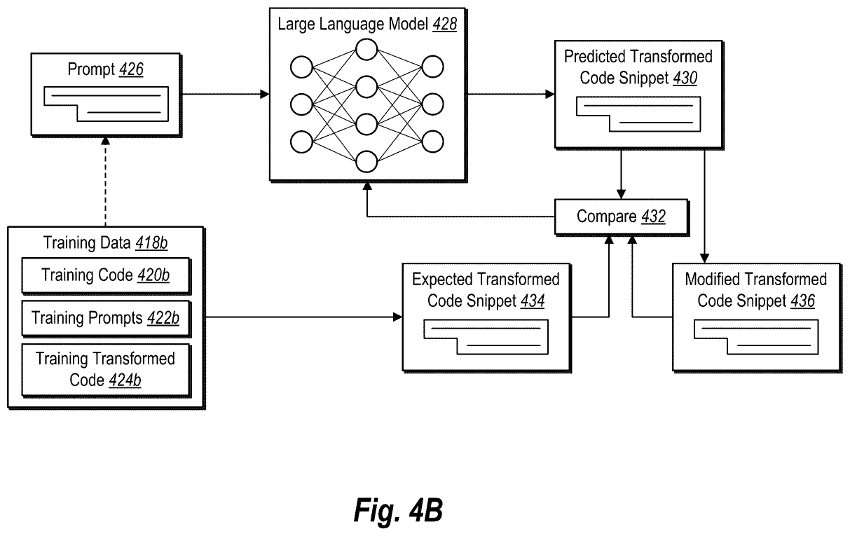

In some implementations, the code transformation system 106 utilizes a prompt model to generate a prompt based on the code snippet 210 and/or the code 208. FIG. 3 illustrates the code transformation system 106 using a prompt model to generate a prompt in accordance with one or more implementations of the present disclosure. FIG. 4A illustrates the code transformation system 106 modifying parameters of a prompt model in accordance with one or more implementations of the present disclosure.

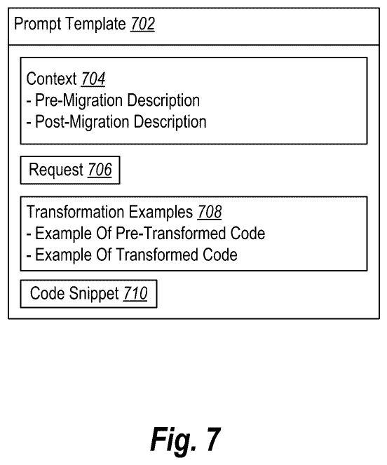

As further illustrated in FIG. 2, the prompt 214 can include various components including context and transformation examples. The code transformation system 106 generates the prompt 214 that is structured to guide an LLM's generation of transformed code. The prompt 214 comprises context, constraints, and expectations to efficiently guide the LLM's output. FIG. 7 illustrates an example prompt template having various components in accordance with one or more implementations of the present disclosure.

FIG. 2 illustrates the code transformation system 106 performing an act 206 of generating a transformed code snippet. The code transformation system 106 can insert the code snippet 210 into a selected prompt template to form a prompt 216. The code transformation system 106 utilizes a large language model 218 to analyze the prompt 216 and the code snippet 210 and generate a transformed code snippet 220.

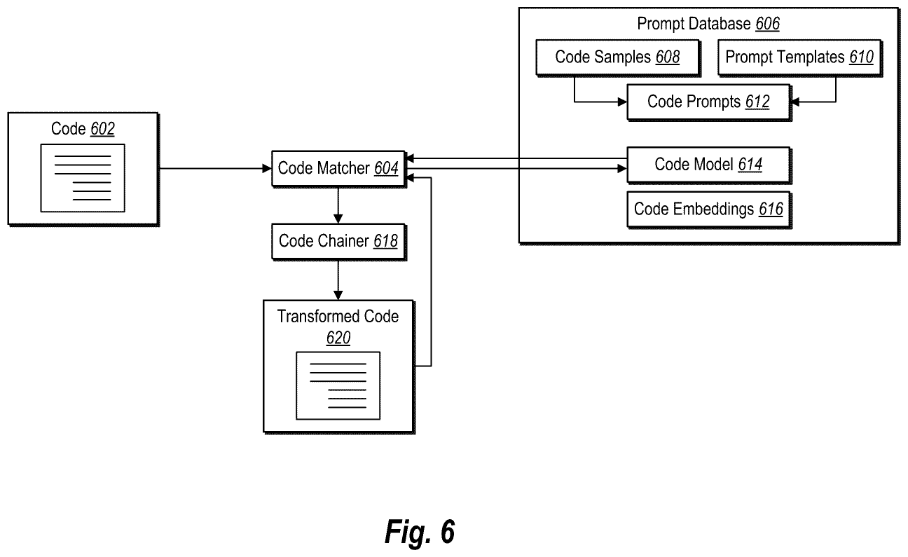

As mentioned, in some implementations, the code transformation system 106 utilizes the large language model 218 to analyze a prompt 216 comprising the code snippet 210 to generate the transformed code snippet 220. In some embodiments, the code transformation system 106 may utilize a code model to generate transformed code based on code. More specifically, the code transformation system 106 instead of segmenting the code into code snippets for transformation, the code transformation system 106 can utilize a code model to analyze and transform the code in preparation for migration. FIG. 6 and the corresponding paragraphs describe the code transformation system 106 using a code model to generate transformed code in accordance with one or more embodiments of the present disclosure.

In some implementations, the code transformation system 106 can receive user input as part of performing the act 206 of generating a transformed code snippet. For example, in some implementations, the code transformation system 106 can provide, via a user interface, a chat assistant or bot to facilitate with code transformations. The chat assistant may receive user input indicating relevant information regarding the code 208 and/or the code snippet 210. In some implementations, the code transformation system 106 communicates the input received via the chat assistant directly to the large language model 218. For example, the code transformation system 106 may communicate the user input to the third-party server(s) 114 either directly or through an API. In another example, the code transformation system 106 uses the chat assistant to receive user input regarding the transformed code snippet 220. For instance, the code transformation system 106 may use the chat assistant to facilitate modifying the transformed code snippet 220.

As mentioned previously, in some implementations, the code transformation system 106 can determine a prompt for code snippet by using an embeddings database. FIG. 3 illustrates the code transformation system 106 using an embeddings database to generate a prompt in accordance with one or more implementations of the present disclosure.

As shown in FIG. 3, the code transformation system 106 accesses a code snippet 302. In some embodiments, the code transformation system 106 generates the code snippet 302 from a code. In some examples, the code transformation system 106 receives the code snippet 302 from a device. In some implementations, the code transformation system 106 pre-processes the code snippet 302 before inserting the code snippet 302 into a selected prompt template 312. More specifically, some large language models have size or other constraints for requests. The code transformation system 106 may pre-process the code snippet 302 to ensure that the code snippet 302 will fit into a request for the large language model 316. For instance, the code transformation system 106 may remove whitespace, perform trims to fall within a code token limit, or apply a Comby template to ensure that the code snippet 302 complies with input requirements for the large language model 316.

As mentioned, the code transformation system 106 inserts the code snippet 302 into a prompt. The code transformation system 106 may determine a prompt based on user input or the code transformation system 106 may automatically identify a prompt. As mentioned previously, the prompt includes various components, including context. Accordingly, the code transformation system 106 can identify a prompt having relevant context. In some embodiments, the code transformation system 106 receives a prompt from a user. In some examples, the code transformation system 106 receives, from a device, (e.g., the client device 108) a prompt to use with a large language model. For instance, a user may indicate a desired prompt comprising context to use as input into a large language model for generating transformed code. A user prompt can include all input components required by the large language model to generate the transformed code. In some examples, the code transformation system 106 can receive certain components of a prompt while generating the remaining components of a prompt. For example, a user may supply transformation examples, and the code transformation system 106 can generate context and the request.

In some implementations, the code transformation system 106 generates a prompt or components of a prompt without user input. As mentioned previously, the code transformation system 106 may determine a prompt by using an embeddings database. FIG. 3 illustrates an embeddings database 306 that the code transformation system 106 may use to determine a prompt and/or components of the prompt.

As shown in FIG. 3, the embeddings database 306 comprises code samples 308 and prompt templates 310. Generally, the embeddings database 306 comprises a data structure used to store and manage embeddings of code samples and their corresponding prompt templates. The code transformation system 106 can build the embeddings database 306 by compiling historical code samples and prompt templates. For example, the code samples 308 and the prompt templates 310 may comprise code snippets and prompts that were manually created by users to input into a large language model. The code samples 308 may comprise code snippets that have been transformed using a large language model. The prompt templates 310 comprise prompts that were used as inputs in conjunction with the code samples 308 into the large language model. The embeddings database 306 comprises mappings between the code samples 308 and their corresponding prompt templates 310.

In some implementations, the code transformation system 106 determines a prompt by comparing a code snippet 302 with the code samples 308 in the embeddings database 306. For example, the code transformation system 106 can match the code snippet 302 with a similar code sample within the embeddings database 306. More specifically, the code transformation system 106 may assume that similar code snippets are associated with similar context and should likely undergo similar transformations. The code transformation system 106 identifies the similar code sample of the code samples 308, which is mapped to a prompt template. In some implementations, the code transformation system 106 utilizes the prompt template as a selected prompt template 312.

In some implementations, the code transformation system 106 trains and utilizes a prompt model 304 to generate prompts for the code snippet 302. The prompt model 304 may comprise a large language model or another type of neural network. The prompt model 304 may be fine-tuned or trained using the embeddings database 306 or another dataset of code snippet-prompt template pairs. During fine-tuning the prompt model 304 learns to generate prompts that are contextually relevant to code snippets. FIG. 4A illustrates the code transformation system 106 fine-tuning the prompt model 304 in accordance with one or more implementations of the present disclosure.

Based on either an output from the prompt model 304, or by identifying a corresponding appropriate prompt template from the embeddings database 306, the code transformation system 106 can identify a selected prompt template 312. The selected prompt template 312 includes context appropriate for the code snippet 302. The code transformation system 106 may further insert the code snippet 302 into the selected prompt template 312 to form a prompt 314.

As shown in FIG. 3, the code transformation system 106 uses the prompt 314 as input into a large language model 316. As mentioned, the prompt 314 comprises written instructions, questions, or context-specific information that helps the large language model 316 understand the desired outcome. The code transformation system 106 can insert the code snippet 302 into the prompt. By providing a code snippet 302 that is a relatively small size, the code transformation system 106 can provide additional context within the selected prompt template 312 that minimizes hallucination, errors, and latency while still achieving code transformation.

The code transformation system 106 utilizes the large language model 316 to analyze and process the prompt 314 including the code snippet 302. FIG. 11 describes an example large language model in accordance with one or more embodiments of the present disclosure.

As further illustrated in FIG. 3, the code transformation system 106 utilizes the large language model 316 to generate a transformed code snippet 318. The transformed code snippet 318 has undergone modifications, alterations, or enhancements to fulfill specific objectives. In some implementations, the code transformation system 106 further evaluates the transformed code snippet 318 to ensure that the transformed code snippet 318 matches desired patterns. For example, the code transformation system 106 can evaluate the transformed code snippet 318 to ensure that the transformed code snippet 318 does not use antipatterns and works as intended. For example, in some implementations, the code transformation system 106 creates lint rules for known antipatterns and antiquated code. The code transformation system 106 analyzes the transformed code snippet 318 utilizing the created lint rules to flag and, in some instances, correct, the transformed code snippet 318.

Additionally, or alternatively, to having the large language model 316 generate the transformed code snippet 318, the code transformation system 106 can cause the large language model 316 to generate a code snippet difference file. As used herein, the term “code difference file” (or simply “difference file”) refers to a file that defines or encodes differences between code. In particular, a code difference file represents differences between code (or code snippets). For example, the difference file can be a non-textual representation of the differences between code such as a file showing changes between a code snippet and a transformed code snippet. In another example, a content difference file can be a textual representation describing or otherwise textually reflecting the differences between code.

In some implementations, the code transformation system 106 utilizes the large language model 316 to output a code difference file. For instance, as part of direct application programming interface (API) integrations, the code transformation system 106 can queue a difference file for manual review. In some implementations, the code transformation system 106 provides the difference file for display via a code transformation user interface. In some implementations, the code transformation system 106 utilizes the large language model 316 to output the large language model 316, and the code transformation system 106 constructs a difference file to associate the transformed code snippet 318 with the code snippet 302.

As illustrated in FIG. 3, the code transformation system 106 can determine to modify the transformed code snippet 318 (or the difference file). In particular, the code transformation system 106 may generate a modified transformed code snippet 320 based on the lint rules. For instance, the code transformation system 106 may adjust or modify the transformed code snippet 318 based on determining that the transformed code snippet 318 contains known antipatterns or antiquated code. For instance, the code transformation system 106 may update the transformed code snippet 318 to remove or update the antipatterns or antiquated code from the transformed code snippet 318 to generate the modified transformed code snippet 320.

In some implementations, the code transformation system 106 generates the modified transformed code snippet 320 based on user input. Additionally, or alternatively, the code transformation system 106 provides the transformed code snippet 318 for display, on a device, via a code transformation user interface. The code transformation system 106 provides additional user interface elements for modifying the transformed code snippet 318. The code transformation system 106 may generate the modified transformed code snippet 320 based on user input or user corrections.

In some embodiments, the code transformation system 106 provides the transformed code snippet 318 and/or the modified transformed code snippet 320 to a user via a code transformation user interface. For example, the code transformation system 106 may use the large language model 316 to apply a single transformation to the code snippet 302 and present the resulting transformed code snippet 318 (or the modified transformed code snippet 320) to the user. In some implementations, and as further described in the paragraphs below, the code transformation system 106 may determine to apply additional transformations to the transformed code snippet 318 and/or the modified transformed code snippet 320.

As illustrated in FIG. 3, in some implementations, the code transformation system 106 determines to apply additional transformations to the transformed code snippet 318 and/or the modified transformed code snippet 320. The code transformation system 106 utilizes a prompt chainer 322 to determine whether the transformed code snippet 318 or the modified transformed code snippet 320 match further transformations based on past transformations without additional user input. For instance, the code transformation system 106 may utilize the prompt chainer 322 to compare the transformed code snippet 318 or the modified transformed code snippet 320 with the code samples 308 in the embeddings database 306 to find a similar code sample. The code transformation system 106 can then identify an additional prompt corresponding to the transformed code snippet 318 and/or the modified transformed code snippet 320. In some implementations, the code transformation system 106 utilizes the code snippet 302 to generate an additional prompt.

In some embodiments, the code transformation system 106 stores and caches additional transformations identified and executed by the prompt chainer 322. For instance, the code transformation system 106 can store a cached response which stores an ordered list of chained prompts. Caching an ordered list of chained prompts serves at least two purposes. First, the code transformation system 106 efficiently stores the work and processes by which a code snippet undergoes multiple transformations. Second, the code transformation system 106 can access the ordered list of chained prompts for future use. For instance, instead of utilizing the prompt chainer 322 to compare a transformed code snippet with the code samples 308 in the embeddings database 306, the code transformation system 106 can access to ordered list of chained prompts to identify past prompts utilized with similar codes. The code transformation system 106 may directly apply an ordered list of chained prompts for a first transformed code snippet to a second transformed code snippet.

The code transformation system 106 may utilize the large language model 316 to generate an additional transformed code snippet based on the additional prompt and the transformed code snippet 318 (or the modified transformed code snippet 320). For instance, the code transformation system 106 inserts the transformed code snippet 318 or the modified transformed code snippet 320 into the additional prompt and inputs the request comprising the additional prompt and the transformed code snippet 318 (or the modified transformed code snippet 320) into the large language model 316. The code transformation system 106 utilizes the large language model 316 to generate an additional transformed code snippet. The code transformation system 106 may iteratively chain prompts to apply multiple transformations to the code snippet 302.

In some implementations, the code transformation system 106 utilizes the prompt chainer 322 to chain prompts based on user input. For example, in some implementations, the code transformation system 106 can receive, from a user, a user-defined sequence of transformations. For instance, the code transformation system 106 may receive, from a device associated with a user, a sequence of transformations to apply to the code snippet 302. The code transformation system 106 may utilize the prompt chainer 322 (or the prompt model 304) to identify a sequence of prompts from the embeddings database 306 that accomplish the user's desired transformations. The code transformation system 106 then iteratively inputs successive prompts within the sequence of prompts and their corresponding transformed code snippets to the large language model 316 to apply the user-defined sequence of transformations to the code snippet 302.

In some examples, the code transformation system 106 utilizes chain of thought reasoning as an optional part of the prompt chaining process. Generally, chain of thought reasoning refers to a process of following a series of prompts or instructions. The code transformation system 106 may utilize the prompt chainer 322 to analyze the transformed code snippet 318 and/or the modified transformed code snippet 320 to comprehend the code snippet and the purpose of the code snippet. The code transformation system 106 may identify steps required to further fulfill the purpose of the code snippet. For example, the code transformation system 106 can identify a task to be completed by the code snippet and generate additional steps required to accomplish the task. The code transformation system 106 may accordingly chain one or more additional prompts from the embeddings database 306 based on the identified tasks.

In one or more embodiments, the code transformation system 106 stores the code snippet 302 together with the transformed code snippet 318 (and/or the modified transformed code snippet 320) in a code repository. In particular, a code repository comprises a centralized location where code and code snippets are stored. The code repository may be accessed by a plurality of client devices associated with a plurality of users. For instance, a code repository can enable multiple users to access and modify the same code snippets or transformed code snippets.

As mentioned, the code transformation system 106 may utilize a prompt model to generate a prompt for a code snippet and a large language model to generate a transformed code snippet. FIGS. 4A-4B illustrate the code transformation system 106 training the prompt model and the large language model in accordance with one or more implementations of the present disclosure. FIG. 4A illustrates the code transformation system 106 training a prompt model to generate a prompt in accordance with one or more embodiments of the present disclosure. FIG. 4B illustrates the code transformation system 106 training and fine tuning a large language model to generate a transformed code snippet in accordance with one or more embodiments of the present disclosure.

As illustrated in FIG. 4A, the code transformation system 106 trains a prompt model 404 using training data 418a comprising training code 420a, training prompts 422a, and training transformed code 424a. For example, the code transformation system 106 may utilize a code snippet 402 from the training data 418a to train the prompt model 404. Additionally, or alternatively, the code transformation system 106 may fine-tune the prompt model 404 with real-world examples. For instance, rather than obtaining the code snippet 402 from the training data 418a, the code transformation system 106 may receive the code snippet 402 from a device. More specifically, the code snippet 402 may be a snippet without a ground truth training prompt or ground truth transformed code snippet.

The training data 418a illustrated in FIG. 4A comprises the training code 420a and the training prompts 422. The training code 420a is paired with the training prompts 422a that, when entered into the large language model, generated the training transformed code 424a. The training code 420a may comprise code or code snippets. The training transformed code 424a may comprise transformed code or transformed code snippets corresponding to the training code 420a.

As illustrated in FIG. 4A, the code transformation system 106 inputs the code snippet 402 into the prompt model 404. The code transformation system 106 utilizes the prompt model 404 to generate a predicted prompt 408. The predicted prompt 408 comprises a prompt automatically generated by the prompt model 404 based on the code snippet 402. The code transformation system 106 inserts the code snippet 402 into the predicted prompt 408 and inputs the predicted prompt 408 into a large language model to generate a predicted transformed code snippet 410.

The code transformation system 106 compares 412 the predicted transformed code snippet 410 with a ground truth transformed code snippet. For instance, the code transformation system 106 may compare the predicted transformed code snippet 410 with an expected transformed code snippet 416 from the training transformed code 424a within the training data 418a.

As further shown in FIG. 4A, the code transformation system 106 may compare 412 the predicted transformed code snippet 410 with a modified transformed code snippet 414. To illustrate, in an example where the code transformation system 106 does not have a ground truth expected transformed code snippet, the code transformation system 106 may modify the predicted transformed code snippet 410 based on lint rules and/or user input. The code transformation system 106 can identify differences between the predicted transformed code snippet 410 and the modified transformed code snippet 414 and utilize those differences to fine-tune the prompt model 404.

As mentioned, the code transformation system 106 may further train or fine tune a large language model to generate transformed code snippets. FIG. 4B illustrates the code transformation system 106 training a large language model to generate transformed code snippets in accordance with one or more embodiments of the present disclosure.

As shown in FIG. 4B the code transformation system 106 inputs a prompt 426 containing a code snippet 402 into a large language model 428. In some examples, the code transformation system 106 utilizes training data 418b comprising data from existing transformations to train the large language model 428. For example, the prompt 426 may comprise a training prompt with a known pre-transformation code and a transformed code. More specifically, the training data 418b comprises training code 420b, training prompts 422b, and training transformed code 424b. The training code 420b comprises pre-transformed code or pre-transformed code snippets, the training prompts 422b comprise the corresponding prompts, and the training transformed code 242b comprises the corresponding transformed code or code snippets.

Additionally, or alternatively, the code transformation system 106 may utilize few shot or in-context learning to train the large language model 428. Generally, instead of requiring access to the training data 418b, the code transformation system 106 can pass examples of pre-transformed code and transformed code through the large language model 428 and ask the large language model 428 to perform a similar pattern transformation on a new input code. In some implementations, the prompt 426 can include the examples of the pre-transformed code and the transformed code. To illustrate, the code transformation system 106 can insert a code snippet into the prompt 426 that is not yet associated with training transformed code. For instance, the prompt 426 may include a code snippet that is provided by a user of a client device. This type of in-context learning allows the large language model 428 to learn and understand the context in which the code is used, making it easier to generate accurate predictions and code transformations.

The code transformation system 106 utilizes the large language model 428 to generate a predicted transformed code snippet 430. The code transformation system 106 compares 432 the predicted transformed code snippet 430 with ground truth examples of the transformed code snippet. More specifically, in examples where the code transformation system 106 performs fine-tuning based on existing transformations, the code transformation system 106 can compare the predicted transformed code snippet 430 with an expected transformed code snippet 434 from the training data 418b.

When utilizing few shot or in-context learning, the code transformation system 106 can compare a modified transformed code snippet 436 with the predicted transformed code snippet 430. For example, and as described previously, the modified transformed code snippet 436 comprises the predicted transformed code snippet 430 that the code transformation system 106 has adjusted or modified. For instance, the code transformation system 106 may generate the modified transformed code snippet 436 based on user input or based on lint rules and automatically applied modifications. The code transformation system 106 adjusts parameters of the large language model 428 based on comparing the predicted transformed code snippet 430 with the expected transformed code snippet 434 and/or the modified transformed code snippet 436.

Few shot/in-context learning and fine tuning based on existing transformations have their own benefits and shortcomings. In some implementations, the large language model 428 has an LLM token limit that limits the size of an input. In some examples, the code transformation system 106 utilizes in-context learning for simple code transformations. More specifically, the context length for in-context learning may be limited, which must often pair with simpler code snippets to fall below an LLM token limit for a large language model. In contrast, if the code transformation system 106 has access to the training data 418b, the code transformation system 106 has access to a lot of training data for fine tuning the large language model 428. Fine tuning the large language model 428 using the training data 418b enables the large language model 428 to understand the transformation with minimal input context. Accordingly, in some instances, the code transformation system 106 may determine to utilize a fine-tuning method with more complex code.

As mentioned previously, in some examples, large language models limit inputs based on an LLM token limit. Specifically, large language models typically have practical limits on the number of tokens they can process in a single input to generate an output. These LLM token limits are determined by factors such as computational resources, memory constraints, and the architecture of the model. In some embodiments, the code transformation system 106 breaks up a code into code snippets for processing by a large language model. FIG. 5 illustrates the code transformation system 106 determining code snippets from code in accordance with one or more embodiments of the present disclosure.

As shown in FIG. 5, the code transformation system 106 receives the code 502. The code transformation system 106 can determine a target code snippet size based on an LLM token limit and an estimated prompt size. In some examples, the LLM token limit is inclusive of an input and output. To illustrate, the LLM token limit refers to the maximum number of tokens or units of text that the LLM can process in a single input and single output, combined. In other examples, the LLM token limit includes only the input size. For example, the LLM token limit refers to the maximum number of tokens or units of text that the LLM can process in a single input.

As mentioned, the code transformation system 106 can further determine a target code snippet size based on an estimated prompt size. In some implementations, the code transformation system 106 predetermines an estimated prompt size based on historical prompts. For instance, the code transformation system 106 can determine the token size of historical prompts and use the mean size as the estimated prompt size. In some examples, the code transformation system 106 determines the estimated prompt size based on a prompt that has been input by the user. For instance, the code transformation system 106 determines that the estimated prompt size equals the input prompt size.

The code transformation system 106 can determine the target code snippet size based on both the LLM token limit and the estimated prompt size. In some implementations, the code transformation system 106 determines the target code snippet size by subtracting the estimated prompt size from the LLM token limit. In cases where the LLM token limit is inclusive of both input and output, the code transformation system 106 further divides the difference between the LLM token limit and the prompt size by two.

The code transformation system 106 may determine the code snippet using the target code snippet size. In some implementations, the code transformation system 106 may employ an agentic approach to deconstructing the code 502 into code snippets 506 and reconstructing transformed code snippets 516 into a transformed code 520. More particularly, the code transformation system 106 may create a plan to use subagent tools to deconstruct and reassemble the code 502 and the transformed code 520, respectively. To illustrate, the code transformation system 106 may utilize a code partitioner 504 to deconstruct the code 502 based on the target code snippet size. For example, the code transformation system 106 utilizes the code partitioner 504 to generate the code snippets 506 such that each of the code snippets 506 falls within the target code snippet size.

The code transformation system 106 further generates prompts 512 corresponding to the code snippets 506. For example, the code transformation system 106 may utilize code context 508 to generate the prompts 512. In some implementations, the code transformation system 106 utilizes a prompt model 510 to generate the prompts 512 corresponding to the code snippets 506. As shown in FIG. 5, the code context 508 comprises context for the code including segments of the code above or below a given code snippet.

The code transformation system 106 further utilizes the large language model large language model 514 to analyze the code snippets 506 and the prompts 512 comprising the code context 508. The large language model 514 generates transformed code snippets 516 corresponding to the input code snippets 506. In some implementations, the code transformation system 106 utilizes the large language model 514 to perform the same transformations on all of the code snippets 506. For example, the code transformation system 106 may use a single prompt while interchanging the code snippets 506 as input to the large language model 514.

As illustrated in FIG. 5, the code transformation system 106 may utilize a code snippet assembler 518 to construct the transformed code 520 based on the transformed code snippets 516. More particularly, as part of forming its plan, the code transformation system 106 maintains data regarding the placement of the code snippets 506 and, accordingly, the transformed code snippets 516 relative to each other.

FIG. 5 illustrates how the code transformation system 106 may automatically (i.e., without user input) deconstruct a complex or large code into component code snippets for processing by a large language model. In some implementations, the code transformation system 106 determines the code snippets 506 based on user input. For example, in some implementations, the code transformation system 106 provides, via a user interface of a device, the code 502. The code transformation system 106 may receive user selection indicating a desired code snippet. For example, the code transformation system 106 may receive a user highlight of a segment of the code 502 and determine that the highlighted segment comprises a code snippet.

In some examples, the code transformation system 106 utilizes a hybrid approach for determining code snippets. For instance, the code transformation system 106 may receive the code 502 and a user selection of a code snippet. The code transformation system 106 may automatically determine additional code snippets that do not overlap with the user-selected code snippet. Accordingly, the code transformation system 106 may use both automatically determined and user-selected code snippets as input into the large language model 514.

FIGS. 3-4B illustrate the code transformation system 106 utilizing and training various models to generate transformed code snippets in accordance with one or more implementations of the present disclosure. In some embodiments, the code transformation system 106 may transform an entire code utilizing an interactive AI assisted transformation approach. FIG. 6 illustrates the code transformation system 106 generating transformed code by using an interactive AI assisted transformation approach in accordance with one or more embodiments of the present disclosure. As shown in FIG. 6, the interactive AI assisted transformation approach comprises three major components: a prompt database 606, a code matcher 604, and a code chainer 618. The following paragraphs describe each of these components in greater detail.

As shown in FIG. 6, the code transformation system 106 utilizes the prompt database 606 to store code samples 608 and prompt templates 610 for a given use case. In particular, the code transformation system 106 maintains the prompt database 606 for a particular transformation use case. For a particular transformation type, the prompt database 606 stores multiple prompt templates 610 and code samples 608. For example, a particular transformation type may contain several prompt templates 610 for different examples of code transformations. The prompt database 606 further stores code prompts 612 comprising associated combinations of the code samples 608 and the prompt templates 610.

The code transformation system 106 utilizes the code model 614 to find the most relevant code prompts 612 which are applicable for a given code snippet. The code transformation system 106 can use an embedding based prompt retrieval to detect the most appropriate prompts for a given code. For instance, the code transformation system 106 utilizes the code model 614 to analyze the code embeddings 616 to retrieve the most applicable code prompt from the code prompts 612 to be applied to the code 602.

The code transformation system 106 utilizes a code matcher 604 to generate transformed code based on the code 602 and the most applicable code prompt. In particular, the code matcher 604 comprises a neural network that attempts to understand the code 602 and communicates with the code model 614 to match the code 602 to the most applicable code prompt from the prompt database 606. The code matcher 604 further applies the most appropriate code prompt to the code 602 to generate the transformed code 620.

As shown in FIG. 6, the code transformation system 106 may further utilize a code chainer 618 to apply additional transformations to the transformed code 620. For example, and as shown, the code transformation system 106 utilizes the code chainer to analyze the transformed code 620 and determine whether additional transformations may be appropriate for the transformed code 620. For instance, the code transformation system 106 may utilize the code model 614 to identify, from within the code embeddings 616, code samples 608 that are similar to the transformed code 620. The code transformation system 106 may accordingly identify additional code prompts to apply to the transformed code 620 utilizing the code matcher 604.

As mentioned previously, the code transformation system 106 may generate prompts corresponding to a code or code snippet. FIG. 7 illustrates an example prompt template in accordance with one or more embodiments of the present disclosure. In particular, FIG. 7 illustrates a prompt template 702 comprising a context 704, a request 706, transformation examples 708, and a code snippet 710.

As illustrated in FIG. 7, the prompt template 702 includes a context 704. Generally, the context refers to surrounding information or background provided to guide the large language model in understanding code to generate more accurate transformed code. The context 704 may include information relating to code segments preceding or following the code snippet 710, relevant facts, instructions, or other relevant information. The context 704 may indicate a first code type of the code and a second code type of the transformed code. For instance, the context 704 may include a pre-transformation description (e.g., indicating that the code is in Python) and a post-transformation description (e.g., indicating that the transformed code should be in Java). Context can also include background information relating to the code. For instance, the context 704 can indicate the purpose of a code and/or its corresponding transformed code.

As shown in FIG. 7, a prompt may include the request 706. The request 706 comprises input text that instructs or asks the large language model to perform a specific task or provide certain information. The request 706 specifies the desired action or output from the model. For example, the request 706 may include a command such as “please return the transformed code.”

As illustrated in FIG. 7, the prompt template 702 comprises the transformation examples 708. The transformation examples 708 comprise instances or samples of input data and output data meant to guide the large language model in understanding the transformation and generating the desired output. For example, the transformation examples 708 comprise an example of pre-transformed code and an example of transformed code. In some implementations, the transformation examples 708 comprise an example of a pre-transformed code snippet and an example of a transformed code snippet.

The prompt template 702 further includes space to insert the code snippet 710. As mentioned previously, the size of the prompt template 702 may be limited by an LLM token limit. In particular, the prompt template 702 may not exceed a target prompt size. In some examples, the target prompt size equals the LLM token limit. In other examples, the target prompt size equals half of the LLM token limit. Accordingly, in some implementations, the code transformation system 106 can vary the sizes of the context 704, the request 706, the transformation examples 708, and the code snippet 710 as to not exceed the target prompt size. For example, based on determining that the code snippet 710 is small, the code transformation system 106 may determine to include additional transformation examples within the transformation examples 708.

Any or all of the components illustrated within the prompt template 702 may be received by the code transformation system 106 from a device. For instance, a user may provide any one of the context 704, the request 706, or the transformation examples 708. In some examples, the code transformation system 106 may automatically generate the context 704, the request 706, and/or the transformation examples 708.

As mentioned, the code transformation system 106 may present, via one or more devices, a code transformation user interface. FIGS. 8A-8C illustrate a series of code transformation user interfaces in accordance with one or more implementations of the present disclosure. While FIGS. 8A-8C illustrate the code transformation user interface on one device, the code transformation system 106 may present the code transformation user interface on multiple devices. For instance, the code transformation system 106 may receive selection of a code snippet via a first user interface at a first client device and provide a corresponding transformed code snippet via a second user interface at a second client device.

FIG. 8A illustrates a code transformation user interface 804a presented on a screen 802 of a device 800 (e.g., the client device 108). As shown in FIG. 8A, the code transformation user interface 804a is presented as part of a web-based application.

The code transformation user interface 804a comprises a project selection element 806. The project selection element 806 indicates a selected project title. Based on user interaction with the project selection element 806, the code transformation system 106 may update the code transformation user interface 804a to include different project titles and their corresponding information.

The code transformation user interface 804a further includes a prompt editor element 818. The prompt editor element 818 displays a prompt for a language learning model. In some implementations, the code transformation system 106 may present a prompt template via the prompt editor element 818. The code transformation system 106 may receive, via the prompt editor element 818 any user entries for components of the prompt template. For instance, the code transformation system 106 may receive, via the prompt editor element 818 entries of transformation examples within the prompt template.

The code transformation system 106 may automatically update components of the prompt template displayed within the prompt editor element 818 based on user interactions with a context selection element 814 and/or an LLM model selection element 816. For example, the context selection element 814 indicates a selected context. As shown in FIG. 8A, the context selection element 814 includes context to convert a code from a first code type (e.g., pig) to a second code type (e.g., spark). The code transformation user interface 804a further comprises the LLM model selection element 816. The code transformation system 106 may access several large language models. The code transformation system 106 may, based on user interaction with the LLM model selection element 816 determine which large language model to use to transform the code or code snippets. In some implementations, the code transformation user interface 804a further includes elements for modifying other components of the prompt template (e.g., request, transformation examples, context, etc.).

The code transformation user interface 804a illustrated in FIG. 8A includes a code display element 834. The code display element 834 displays code and/or a code snippet. For example, as shown in FIG. 8A, the code display element 834 includes code for the Pig project. In some examples, the code transformation system 106 receives the code and/or the code snippet through user interaction with the code display element 834. A user may type or paste the code or code snippet into the code display element 834. Additionally, in some implementations, the code transformation system 106 may receive an indication of a code snippet from code inserted in the code display element 834. For example, in some embodiments, the code transformation system 106 may receive the code in code display element 834. The code transformation system 106 may receive an indication of a code snippet within the code via the code display element 834. For example, a user may highlight or otherwise select a code snippet within the code display element 834.

FIG. 8A further illustrates a play element 832 within the code transformation user interface 804a. Based on user interaction with the play element 832, the code transformation system 106 may utilize the large language model to generate a transformed code or transformed code snippet. In some examples, the code transformation system 106 automatically provides a transformed code snippet for display without user interaction with the play element 832. For instance, in some implementations, the code transformation system 106 automatically displays a transformed code snippet based on user input of the code or user selection of a code snippet.

The code transformation user interface 804a illustrated in FIG. 8A further includes a token counter 808 and an estimated remaining token count 810. The token counter 808 corresponds with the LLM token limit. For example, the token counter 808 may display a ratio of consumed tokens to total tokens within a target code snippet size (based on the LLM token limit and the estimated prompt size). For example, and as shown in FIG. 8A, the token counter 808 indicates 238 consumed tokens over 1906 total tokens within the target code snippet size. The consumed tokens indicate tokens consumed by a code or a currently selected code snippet displayed within the code display element 834.

FIG. 8B illustrates a code transformation user interface 804b displaying a transformed code snippet within a transformed code display element 822. In particular, FIG. 8B illustrates the code transformation user interface 804b presented on the screen 802 of the device 800.

As shown in FIG. 8B, the transformed code display element 822 includes transformed code. In some implementations, the transformed code display element 822 presents a plurality of candidate transformed code. Additionally, in some implementations, the transformed code display element 822 presents a transformed code snippet corresponding with a code snippet entered into the code display element 834. In some implementations, the code transformation system 106 may receive user modifications to the transformed code snippet via the transformed code display element 822. For instance, the code transformation system 106 may receive user selections and modifications of the transformed code snippet through the transformed code display element 822.

In some implementations, the code transformation system 106 provides a modification assistant for modifying transformed code via the code transformation user interface. FIG. 8C illustrates a code transformation user interface 804c presented via the screen 802 of the device 800 including a modification assistant window 826. As mentioned previously, the code transformation system 106 may receive user modifications of transformed code via the transformed code display element. In some implementations, the code transformation system 106 provides a modification assistant element to facilitate making changes to a transformed code snippet.

As shown in FIG. 8C, based on user selection of a modification assistant element 836, the code transformation system 106 provides, for display via the code transformation user interface 804c, the modification assistant window 826. The modification assistant window 826 provides, to a device, options to further modify or make additional transformations to the transformed code presented in a transformed code display element 824. For instance, the code transformation system 106 may present a series of cues via the modification assistant window 826. As illustrated in FIG. 8C, the code transformation system 106 presents a cue asking a user if the user wishes to perform more transformations on the displayed transformed code. The cue further includes a selectable element by which a user may select a desired additional transformation to perform on the transformed code snippet.

In some examples, the modification assistant element 836 is a user interface element associated with a chat assistant. FIG. 8C illustrates how the code transformation system 106 may utilize the chat assistant to receive user input for modifying a transformed code snippet. In some implementations, the code transformation system 106 may utilize a chat assistant to receive user input regarding a code snippet or code. For instance, a user may input, into the modification entry element 828 requests or information regarding a selected code snippet before the code snippet has undergone transformation.

In addition to receiving a user selection of predetermined additional transformations, the code transformation system 106 may receive additional modifications to the transformed code snippet via a modification entry element 828. For instance, the code transformation system 106 has received, via the modification entry element 828, a user request to “replace ‘NAME’ with Benjamin.” Based on this user input received via the modification entry element 828, the code transformation system 106 modifies the transformed code by replacing “NAME” with “Benjamin.” This change is indicated within the transformed code display element 824. The modification assistant window 826 further includes an execute element 830. Based on detecting user interaction with the execute element 830, the code transformation system 106 performs a modification entered into the modification entry element 828.

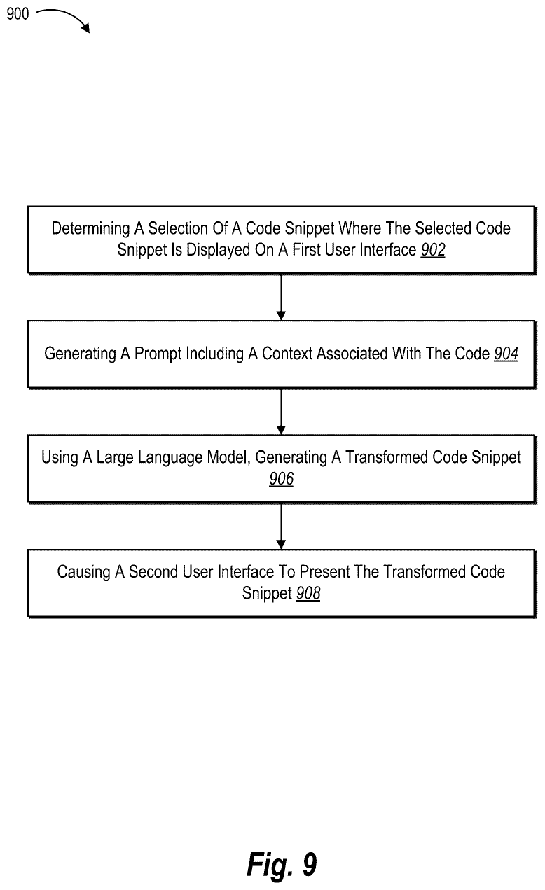

FIGS. 1-8C, the corresponding text, and the examples provide a number of different systems, methods, and non-transitory computer readable media for providing synopses of user account activity changes and/or actual content changes using a large language model. In addition to the foregoing, embodiments, can also be described in terms of flowcharts comprising acts for accomplishing a particular result. For example, FIG. 9 illustrates a flowchart of example sequences of acts in accordance with one or more embodiments.

While FIG. 9 illustrates acts according to some embodiments, alternative embodiments, may omit, add to, reorder, and/or modify any of the acts shown in FIG. 9. The acts of FIG. 9 can be performed as part of a method. Alternatively, a non-transitory computer readable medium can comprise instructions, that when executed by one or more processors, cause a computing device to perform the acts of FIG. 9. In still further embodiments, a system can perform the acts of FIG. 9. Additionally, the acts described herein may be repeated or performed in parallel with one another or in parallel with different instances of the same or other similar acts.

FIG. 9 illustrates a series of acts 900 for providing a transformed code snippet using a large language model. The series of acts 900 can include an act 902 determining a selection of a code snippet where the selected code snippet is displayed on a first user interface. In particular, the act 902 comprises determining a selection of a code snippet from a code associated with a first code type and where the selected code snippet is displayed on a first user interface of a device. The series of acts 900 further includes an act 904 of generating a prompt including a context associated with the code. The act 904 further comprises based on the selection of the code snippet, generating a prompt comprising a context associated with the code, wherein the context is related to a functionality of the code. Additionally, the series of acts 900 comprises an act 906 of using a large language model, generating a transformed code snippet. The act 906 comprises using a large language model, generating a transformed code snippet of a second code type using the code and the context and based on the large language model understanding of the context of the code. The series of acts 900 may further comprise an act 908 of causing a second user interface to present the transformed code snippet. The act 908 further comprises causing a second user interface of a device to present the transformed code snippet corresponding to the code snippet.

In some implementations, the series of acts 900 comprises additional acts of determining a second code snippet from the code; generating a second prompt comprising the context associated with the code and the second code snippet; generating, using the large language model, a second transformed code snippet based on the large language model understanding of the context of the code; combining the transformed code snippet and the second transformed code snippet; and causing the second user interface of the device to present the combined transformed code snippet and the second transformed code snippet.

In some implementations, the series of acts 900 comprises additional acts of generating a plurality of candidate transformed code snippets using the large language model; and causing the second user interface of the device to present the plurality of candidate transformed code snippets.

In some implementations, the series of acts 900 comprises additional acts of providing the transformed code snippet to a code repository.

In some implementations, the series of acts 900 comprises additional acts of generating, using the large language model, one or more additional transformed code snippets; and generating a transformed code based on the transformed code snippet and the one or more additional transformed code snippet, wherein the transformed code has the functionality of the code.

In some implementations, the series of acts 900 comprises additional acts of generating the prompt by: accessing an embeddings database comprising prompt templates and code samples; comparing the code snippet with the code samples in the embeddings database; and identifying, from the embeddings database, a prompt template corresponding with the code snippet.

In some implementations, the series of acts 900 comprises additional acts of generating the prompt by: accessing an embeddings database comprising prompt templates and code samples; comparing the code with the code samples in the embeddings database; and identifying, from the embeddings database, a prompt template corresponding with the code.

In some implementations, the series of acts 900 comprises additional acts of determining, based on the transformed code snippet, an additional prompt comprising an additional context; generating, utilizing the large language model, an additional transformed code snippet of a third code type based on the transformed code snippet and the additional prompt; and providing the additional transformed code snippet corresponding to the transformed code snippet.

In some implementations, the series of acts 900 comprises additional acts of receiving, from the device and via the second user interface, a modification to the transformed code snippet; and generating, based on the modification, a modified transformed code snippet.

In some implementations, the prompt further comprises one or more transformation examples comprising: an example of pre-transformed code; and an example of transformed code.

The components of the code transformation system 106 can include software, hardware, or both. For example, the components of the code transformation system 106 can include one or more instructions stored on a computer-readable storage medium and executable by processors of one or more computing devices. When executed by one or more processors, the computer-executable instructions of the code transformation system 106 can cause a computing device to perform the methods described herein. Alternatively, the components of the code transformation system 106 can comprise hardware, such as a special purpose processing device to perform a certain function or group of functions. Additionally, or alternatively, the components of the code transformation system 106 can include a combination of computer-executable instructions and hardware.

Furthermore, the components of the code transformation system 106 performing the functions described herein may, for example, be implemented as part of a stand-alone application, as a module of an application, as a plug-in for applications including content management applications, as a library function or functions that may be called by other applications, and/or as a cloud-computing model. Thus, the components of the code transformation system 106 may be implemented as part of a stand-alone application on a personal computing device or a mobile device.

Embodiments of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates a block diagram of exemplary computing device 1000 (e.g., the server device(s) 102 and/or the client device 108) that may be configured to perform one or more of the processes described above. One will appreciate that server device(s) 102 and/or the client device 108 may comprise one or more computing devices such as computing device 1000. As shown by FIG. 10, computing device 1000 can comprise processor 1002, memory 1004, storage device 1006, I/O interface 1008, and communication interface 1010, which may be communicatively coupled by way of communication infrastructure 1012. While an exemplary computing device 1000 is shown in FIG. 10, the components illustrated in FIG. 10 are not intended to be limiting. Additional or alternative components may be used in other implementations. Furthermore, in certain implementations, computing device 1000 can include fewer components than those shown in FIG. 10. Components of computing device 1000 shown in FIG. 10 will now be described in additional detail.

In particular implementations, processor 1002 includes hardware for executing instructions, such as those making up a computer program. As an example and not by way of limitation, to execute instructions, processor 1002 may retrieve (or fetch) the instructions from an internal register, an internal cache, memory 1004, or storage device 1006 and decode and execute them. In particular implementations, processor 1002 may include one or more internal caches for data, instructions, or addresses. As an example and not by way of limitation, processor 1002 may include one or more instruction caches, one or more data caches, and one or more translation lookaside buffers (TLBs). Instructions in the instruction caches may be copies of instructions in memory 1004 or storage device 1006.

Memory 1004 may be used for storing data, metadata, and programs for execution by the processor(s). Memory 1004 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 1004 may be internal or distributed memory.

Storage device 1006 includes storage for storing data or instructions. As an example and not by way of limitation, storage device 1006 can comprise a non-transitory storage medium described above. Storage device 1006 may include a hard disk drive (HDD), a floppy disk drive, flash memory, an optical disc, a magneto-optical disc, magnetic tape, or a Universal Serial Bus (USB) drive or a combination of two or more of these. Storage device 1006 may include removable or non-removable (or fixed) media, where appropriate. Storage device 1006 may be internal or external to computing device 1000. In particular implementations, storage device 1006 is non-volatile, solid-state memory. In other implementations, Storage device 1006 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 1008 allows a user to provide input to, receive output from, and otherwise transfer data to and receive data from computing device 1000. I/O interface 1008 may include a mouse, a keypad or a keyboard, a touch screen, a camera, an optical scanner, network interface, modem, other known I/O devices or a combination of such I/O interfaces. I/O interface 1008 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 1008 is configured to provide graphical data to a display for presentation to a user. The graphical data may be representative of one or more graphical user interfaces and/or any other graphical content as may serve a particular implementation.

Communication interface 1010 can include hardware, software, or both. In any event, communication interface 1010 can provide one or more interfaces for communication (such as, for example, packet-based communication) between computing device 1000 and one or more other computing devices or networks. As an example and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 1010 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 1010 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 1010 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 1012 may include hardware, software, or both that couples components of computing device 1000 to each other. As an example and not by way of limitation, communication infrastructure 1012 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

As mentioned, the code transformation system 106 can use a language learning model to generate transformed code. FIG. 11 illustrates an example large language model in accordance with one or more embodiments of the present disclosure. Large Language Models (LLMs) work by employing various neural network components and techniques to process and generate text. FIG. 11 illustrates various components of an example LLM. The LLM illustrated in FIG. 11 may comprise the large language model 116 illustrated in FIG. 1. In particular, the LLM illustrated in FIG. 11 may be hosted, all or in part, on a storage of a client device (e.g., client device 108), a third-party server (e.g., the third-party server(s) 114), and/or on a server device (e.g., the device(s) 102).

As shown in FIG. 11, an LLM can take raw text inputs, typically represented as sequences of tokens such as words or characters. These inputs could be anything from a single sentence to a lengthy document. For example, an input may include code.

Before processing the input sequence, the LLM transforms each token into dense numerical vectors called input embeddings. These embeddings capture semantic information about the tokens and help the LLM understand the meaning of the input.

Because LLMs process sequences of tokens, LLMs need to understand the order of these tokens. Positional encodings are added to the input embeddings to provide information about the position of each token in the sequence. This helps the model learn the sequential structure of the input.

As further shown in FIG. 11, the LLM can comprise a multi-head attention layer. Attention mechanisms are crucial for LLMs to focus on different parts of the input sequence when making predictions or generating text. Multi-head attention layers enhance this capability by using multiple sets of attention weights, allowing the model to attend to different aspects of the input simultaneously.

As illustrated in FIG. 11, the LLM may include add & norm layers. In this step, residual connections are added to the outputs of the multi-head attention layer to facilitate the flow of information through the network. Residual connections allow the model to bypass certain layers, mitigating the vanishing gradient problem and enabling easier training of deeper networks. After adding the residual connections, layer normalization is applied to stabilize the activations across the different dimensions of the output tensor. Layer normalization normalizes the values along each feature dimension, ensuring that the model's outputs are consistent and easier to train.

Following the Add & Norm step, and as shown in FIG. 11, the output from the multi-head attention layer undergoes processing through a feed-forward neural network. This feed-forward network typically consists of two linear transformations with a non-linear activation function in between, such as ReLU (Rectified Linear Unit). The feed-forward network introduces additional non-linearities and enables the model to capture complex patterns in the data.

After the feed-forward processing, the LLM in FIG. 11 performs another Add & Norm step. Similar to the first Add & Norm step, residual connections are added to the output of the feed-forward network, followed by layer normalization to stabilize the activations. This ensures that the model can effectively incorporate the information learned from both the multi-head attention layer and the feed-forward network.

As further illustrated in FIG. 11, the LLM further processes outputs by leveraging different neural network components.

As shown, in FIG. 11, the output embedding is initially processed through a masked multi-head attention mechanism. This mechanism allows each token in the sequence to attend to all other tokens in the sequence, including itself, while preventing attending to future tokens. This is achieved by applying a mask to the attention scores, ensuring that each token can only attend to previous tokens in the sequence. Masked multi-head attention helps the model capture dependencies within the input sequence without peeking into the future.

Following the masked multi-head attention, the LLM passes the output through an Add & Norm layer. This layer adds the input of the masked multi-head attention layer to its output, facilitating the flow of information through the network via residual connections. After the addition operation, layer normalization is applied to stabilize the activations across different dimensions of the output tensor. Layer normalization ensures that the model's outputs are consistent and easier to train.

Next, and as shown in FIG. 11, the output of the Add & Norm layer undergoes processing through another multi-head attention mechanism. Unlike the masked multi-head attention, this step typically involves allowing each token to attend to all other tokens in the sequence without any masking. Multi-head attention helps the model capture global dependencies within the input sequence, enabling it to understand the context of each token more effectively.

Similar to the previous step, the output of the multi-head attention layer is combined with its input using residual connections in an Add & Norm layer. Layer normalization is then applied to stabilize the activations.

After the Add & Norm layer, the output passes through a feed-forward neural network. This network typically consists of two linear transformations with a non-linear activation function (such as ReLU) in between. The feed-forward network introduces additional non-linearities and enables the model to capture complex patterns in the data.

Following the feed-forward processing, another Add & Norm step is performed. This step adds the output of the feed-forward network to its input, followed by layer normalization to stabilize the activations.

The output of the Add & Norm layer is then passed through a linear transformation. This linear transformation projects the output into a high-dimensional space, preparing it for the final softmax activation.

After the linear transformation, softmax activation is applied to the output. Softmax converts the raw output scores into probabilities, ensuring that they sum up to 1. This allows the model to output a probability distribution over the possible tokens or classes in the output sequence.

The softmax activation produces output probabilities indicating the likelihood of each token in the output sequence. These probabilities represent the model's predictions for the next token in the sequence, allowing it to generate coherent and contextually appropriate text or code.

In summary, the example LLM illustrated in FIG. 11 combines input embeddings, positional encodings, attention mechanisms, linear layers, feed-forward layers, softmax activation, and output embeddings to process and generate human-like text based on the input they receive. Through training on large datasets, these models learn to understand and generate coherent and contextually appropriate text across a wide range of tasks. FIG. 11 illustrates example components and features of an LLM. An LLM may include any other combination of components and features.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalisation tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A system comprising:
at least one processor; and
a non-transitory computer readable medium storing instructions that, when executed by the at least one processor, cause the system to:
determine a selection of a code snippet from a code associated with a first code type and where the selected code snippet is displayed on a first user interface of a device;
based on the selection of the code snippet, generate a prompt comprising a context associated with the code, wherein the context is related to a functionality of the code;
using a large language model, generate a transformed code snippet of a second code type using the code and the context and based on the large language model understanding of the context of the code; and
causing a second user interface of a device to present the transformed code snippet corresponding to the code snippet.

2. The system of claim 1, further storing instructions that, when executed by the at least one processor, cause the system to:
determine a second code snippet from the code;
generate a second prompt comprising the context associated with the code and the second code snippet;
generate, using the large language model, a second transformed code snippet based on the large language model understanding of the context of the code;
combine the transformed code snippet and the second transformed code snippet; and
cause the second user interface of the device to present the combined transformed code snippet and the second transformed code snippet.

3. The system of claim 1, further storing instructions that, when executed by the at least one processor, cause the system to:
generate a plurality of candidate transformed code snippets using the large language model; and
cause the second user interface of the device to present the plurality of candidate transformed code snippets.

4. The system of claim 1, further storing instructions that, when executed by the at least one processor, cause the system to provide the transformed code snippet to a code repository.

5. The system of claim 1, further storing instructions that, when executed by the at least one processor, cause the system to generate the prompt by:
accessing an embeddings database comprising prompt templates and code samples;
comparing the code snippet with the code samples in the embeddings database; and
identifying, from the embeddings database, a prompt template corresponding with the code snippet.

6. The system of claim 1, further storing instructions that, when executed by the at least one processor, cause the system to:
generate, using the large language model, one or more additional transformed code snippets; and
generate a transformed code based on the transformed code snippet and the one or more additional transformed code snippet, wherein the transformed code has the functionality of the code.

7. The system of claim 1, further storing instructions that, when executed by the at least one processor, cause the system to:
determine, based on the transformed code snippet, an additional prompt comprising an additional context;
generate, utilizing the large language model, an additional transformed code snippet of a third code type based on the transformed code snippet and the additional prompt; and
provide the additional transformed code snippet corresponding to the transformed code snippet.

8. The system of claim 1, wherein the prompt further comprises one or more transformation examples comprising:
an example of pre-transformed code; and
an example of transformed code.

9. The system of claim 1, further storing instructions that, when executed by the at least one processor, cause the system to:
receive, from the device and via the second user interface, a modification to the transformed code snippet; and
generate, based on the modification, a modified transformed code snippet.

10. A computer-implemented method comprising:
displaying, via a code transformation user interface on a device, a code of a first code type;
generating, based on a selection of a code snippet from the code, a prompt comprising a context associated with the code, wherein the context is related to a functionality of the code;
generating, using a large language model, a transformed code snippet of a second code type based on the prompt and the code snippet; and
providing, for display via the code transformation user interface, the transformed code snippet corresponding to the code snippet.

11. The computer-implemented method of claim 10, further comprising providing, for display via a second code transformation user interface, the code snippet and the transformed code snippet.

12. The computer-implemented method of claim 10, further comprising:
determining a second code snippet from the code;
generating a second prompt comprising the context associated with the code;
generating, using the large language model, a second transformed code snippet based on the second prompt and the second code snippet;
combining the transformed code snippet and the second transformed code snippet; and
providing, for display via the code transformation user interface, the combined transformed code snippet and the second transformed code snippet.

13. The computer-implemented method of claim 10, further comprising generating the prompt by:
accessing an embeddings database comprising prompt templates and code samples;
comparing the code snippet with the code samples in the embeddings database; and
identifying, from the embeddings database, a prompt template corresponding with the code snippet.

14. The computer-implemented method of claim 10, further comprising:
determining, based on the transformed code snippet, an additional prompt comprising an additional context;
generating, utilizing the large language model, an additional transformed code snippet of a third code type based on the transformed code snippet and the additional prompt; and
providing, for display via the code transformation user interface, the additional transformed code snippet corresponding to the transformed code snippet.

15. The computer-implemented method of claim 10, further comprising:
receiving, from the device and via the user interface, a modification to the transformed code snippet; and
generating, based on the modification, a modified transformed code snippet.

16. A non-transitory computer readable medium storing instructions that, when executed by at least one processor, cause the at least one processor to:
display, via a code transformation user interface, a code of a first code type;
generate, based on a selection of a code snippet from the code, a prompt comprising a context associated with the code, wherein the context is related to a functionality of the code;
generate, using a large language model, a transformed code snippet of a second code type based on the prompt and the code snippet; and
provide, for display via the code transformation user interface, the transformed code snippet corresponding to the code snippet.

17. The non-transitory computer readable medium of claim 16, further storing instructions that, when executed by the at least one processor, cause the at least one processor to provide, for display via a second code transformation user interface, the code snippet and the transformed code snippet.

18. The non-transitory computer readable medium of claim 16, further storing instructions that, when executed by the at least one processor, cause the at least one processor to:
determine a second code snippet from the code;
generate a second prompt comprising the context associated with the code;
generate, using the large language model, a second transformed code snippet based on the second prompt and the second code snippet;
combine the transformed code snippet and the second transformed code snippet; and
provide, for display via the code transformation user interface, the combined transformed code snippet and the second transformed code snippet.

19. The non-transitory computer readable medium of claim 16, further storing instructions that, when executed by the at least one processor, cause the at least one processor to generate the prompt by:
accessing an embeddings database comprising prompt templates and code samples;
comparing the code snippet with the code samples in the embeddings database; and
identifying, from the embeddings database, a prompt template corresponding with the code snippet.

20. The non-transitory computer readable medium of claim 16, further storing instructions that, when executed by the at least one processor, cause the at least one processor to:
determine, based on the transformed code snippet, an additional prompt comprising an additional context;
generate, utilizing the large language model, an additional transformed code snippet of a third code type based on the transformed code snippet and the additional prompt; and
provide, for display via the code transformation user interface, the additional transformed code snippet corresponding to the transformed code snippet.
